(19) United States
(12) Patent Application Publication
(10) Pub. No.: US 2009/0079831 A1
(43) Pub. Date: Mar. 26, 2009

(54) DYNAMIC TRACKING OF INTRUDERS ACROSS A PLURALITY OF ASSOCIATED VIDEO SCREENS

(75) Inventors: Rajeshkumar Thappali Sethuraman, Madurai (IN); Marine Drive, Bangalore (IN); Shanmugam Selvarajan, Bangalore (IN); Vijay Dhamija, Bangalore (IN); Robert Blasofsel, Louisville, KY (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 12/206,071

(22) Filed: Sep. 8, 2008

Related U.S. Application Data
(60) Provisional application No. 60/974,483, filed on Sep. 23, 2007.

(51) Int. Cl. H04N 7/18; H04N 5/225

(52) U.S. Cl. 348/153; 348/159; 348/169; 348/222.1; 348/E07.085

(57) ABSTRACT

Tracking an intruder throughout regions in an area under surveillance by locating video cameras to provide an image for each region. For each camera a subset of the cameras are associated as auxiliary cameras to that camera; these associations are stored in a table. One camera is the initial primary camera and displays an initial primary image. An auxiliary video image is displayed for each of the auxiliary cameras that were previously associated with the initial primary camera. An intruder travels from region to region and leaves the primary video image and/or appears in an auxiliary video image. The user selects one of the auxiliary cameras to become a subsequent primary camera, and the video image from the subsequent primary camera is displayed as a subequent primary image. A video image for each of the auxiliary cameras previously associated with the subsequent primary camera will be displayed.

### CROSS-REFERENCE TO RELATED APPLICATIONS

This application claims the benefit and filing priority of copending U.S. provisional application 60/974,483 filed Sep. 23, 2007.

### TECHNICAL FIELD

This invention relates to video surveillance, and in particular to a method of and system for dynamically tracking intruders across a plurality of associated video screens.

### BACKGROUND OF THE INVENTION

Tracking incidents or persons across a set of related video cameras in a video surveillance system is one of the most routine tasks performed by the surveillance operator. The trigger for this activity can be an alarm or other event from the system or the result of active surveillance in observation of an area. For example, an invalid card swipe may occur at an entrance location and the operator wants to quickly view all possible exits from that particular door with the corresponding camera. Another trigger could occur when an operator is watching a game table in a casino and sees someone stealing or cheating in the game and start to walk away, where the operator needs to follow him easily and cover all his possible movements. There are of course other scenarios in which this operation is useful or performed by the operator.

Existing solutions usually involve manually remembering the related cameras and pulling them up in advance by the operator. This requires knowledge from the operator about the details of the system memorized. More advanced solutions use a complex video analytics algorithm, which is a brute force approach that does an analysis of the data across all cameras. This is error prone and the technology has not matured to deploy it easily in any facility without the need to have expensive equipment. Also, object identification across cameras has not been an easy to solve technical problem resulting in false analysis.

The result is that the existing solutions in the market are not straight forward or easy to use and hence operational efficiency to handle the situation by the end user is convoluted.

The present invention addresses this problem by providing a system and method for pre-associating selected video cameras with each other and allowing the operator to manually select a desired camera to cause those previously associated cameras to also come into view, thus enabling a video pursuit of the suspect.

### DISCLOSURE OF THE INVENTION

The present invention is a method of and system for tracking an object of interest throughout an area under surveillance that is made up of a plurality of regions. A plurality of video cameras are strategically located so as to provide a video image associated with each of the regions. For each of the video cameras as a primary video camera, a subset of the video cameras are associated as auxiliary video cameras to that primary video camera. These associations may be stored in a table in computer memory, for example.

One of the video cameras is selected as an initial primary video camera to display a video image on a display as an initial primary video image. In addition, an auxiliary video image is displayed for each of the subset of auxiliary video cameras that were previously associated with the initial primary video camera. This may be for example in a matrix format with the primary video image in the center and the auxiliary video images in sections surrounding the primary video image.

As an intruder or object of interest travels from region to region throughout the area under surveillance, he or it will leave the primary video image and/or appear in an auxiliary video image. Then the user may select one of the auxiliary video cameras to become a subsequent primary video camera, and the video image from the subsequent primary video camera will be displayed as a subequent primary video image. In addition, a video image for each of the subset of auxiliary video cameras previously associated with the subsequent primary video camera will be displayed. This process may be repeated so that the user can easily track the intruder throughout he region.

### BRIEF DESCRIPTION OF THE DRAWING

FIG. 1 is a screen shot of the present invention.

FIG. 2 illustrates a video camera layout of a building under surveillance with intruder X at camera C14.

FIG. 3 illustrates the video camera layout of the building under surveillance of FIG. 2 with intruder X at camera C13.

FIG. 4 illustrates the video camera layout of the building under surveillance of FIG. 2 with intruder X at camera C11.

FIG. 5 illustrates the surveillance monitor of the present invention showing the main viewing zone and eight auxiliary viewing zones.

FIG. 6 illustrates the surveillance monitor of the present invention with camera C14 in the main viewing zone.

FIG. 7 illustrates the surveillance monitor of the present invention with camera C13 in the main viewing zone.

FIG. 8 illustrates the surveillance monitor of the present invention with camera C11 in the main viewing zone.

FIG. 9 is a flowchart of the operation of the present invention.

FIG. 10 is a logic block diagram showing the operation of the present invention.

### BEST MODE FOR CARRYING OUT THE INVENTION

The present invention is a system and method of using a plurality of video images such as real-time video feeds from a plurality of video cameras in order to quickly and easily track and follow an object or person throughout an area under surveillance such as a warehouse facility. In this invention, the facility being monitored is on a large scale such that a single camera cannot capture the entire area under surveillance. The area under surveillance may be divided into a number of regions, and then a plurality of security video cameras are strategically located so as to provide a video image associated with each of the regions, for example to cover all entrances and exits, windows, hallways, rooms, etc. The video feed input signals from the cameras are fed into a central or common monitoring location and processed such that they can be viewed on a computer monitor and manipulated by an associated computer system.

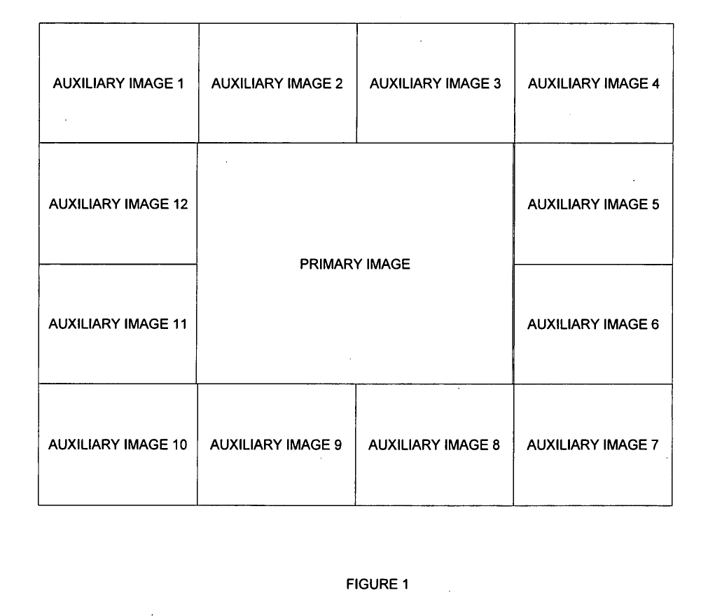

As shown in FIG. 1, provided is a panel layout on the display that displays video images from multiple video cameras as selected in accordance with this invention. By displaying the appropriate video images, a suspect or intruder may be tracked as he travels from region to region throughout the area under surveillance, thus enabling his detention or capture as may be desired. For example, if an intruder is detected attempting to use a bogus card to swipe a terminal and enter a room in a secure building, and then attempts to flee when his entry is denied, this invention allows an operator to easily track the intruder as he travels from one region to the next one, etc.

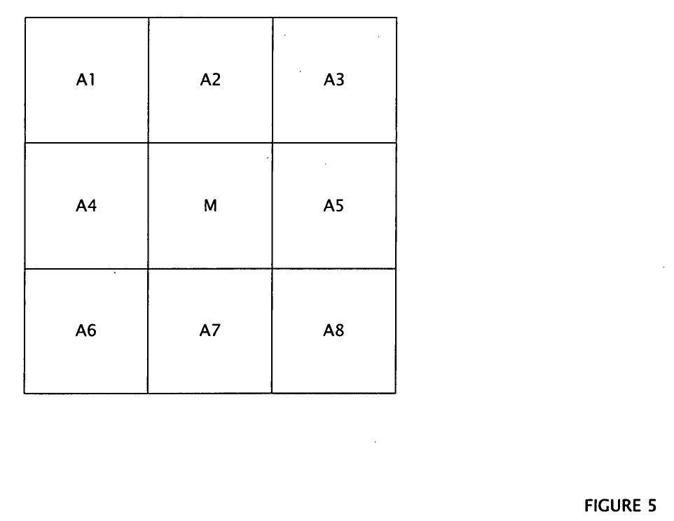

FIG. 5 illustrates a primary or main video image of interest (M) and eight associated auxiliary video images A1-A8 (although more or less associated auxiliary video images may be used on the same or multiple display screens). If an operator sees a suspicious activity in any of the regions (defined by each video image), he may select that auxiliary video image screen with a computer mouse and drag it into the main area M. Then the selected auxiliary video image will appear in the main area M, and all of the auxiliary video images from the video cameras associated with the selected video image will appear in the surrounding auxiliary areas A1-A8. That is, when the user selects one of the auxiliary video cameras to become a subsequent primary video camera, then the video image from the subsequent primary video camera will be displayed as a subsequent primary video image and a video image for each of the subset of auxiliary video cameras previously associated with the subsequent primary video camera will be displayed. As such, the operator will have the area of interest in the main (primary) screen and all of the surrounding camera images in the perimeter of the center screen. An example of this is shown in FIG. 1, where 12 auxiliary views surround the main view in the center of the screen.

The invention is based on configuring each video camera with a group of associated auxiliary video cameras. For example, when a first video camera that monitors a door leading from a hallway to a room is considered to be the primary video camera (i.e. its images are displayed in the primary or center viewing area), then that video camera as primary video camera may have the following auxiliary video cameras associated with it: a second camera monitoring the inside of the room, a third camera monitoring one end of the hall, a fourth camera monitoring another end of the hall, a fifth camera monitoring the door to another room directly across from the first room, etc. Similarly, when the third camera (that monitors the end of the hall) is considered to be the primary video camera, it may have the following auxiliary cameras associated with it: the fourth camera that monitors the other end of the hall as mentioned above, the first and fifth cameras that monitor the room doors as mentioned above, and a sixth camera that monitors the stairs leading up from the end of the hall, and a seventh camera that monitors the stairs leading down from the end of the hall, etc. This can logically be extended for every video camera in the area under surveillance. As such, each video camera when acting as a primary video camera has a plurality of associated auxiliary video cameras that effectively expand the area being monitored by that particular camera.

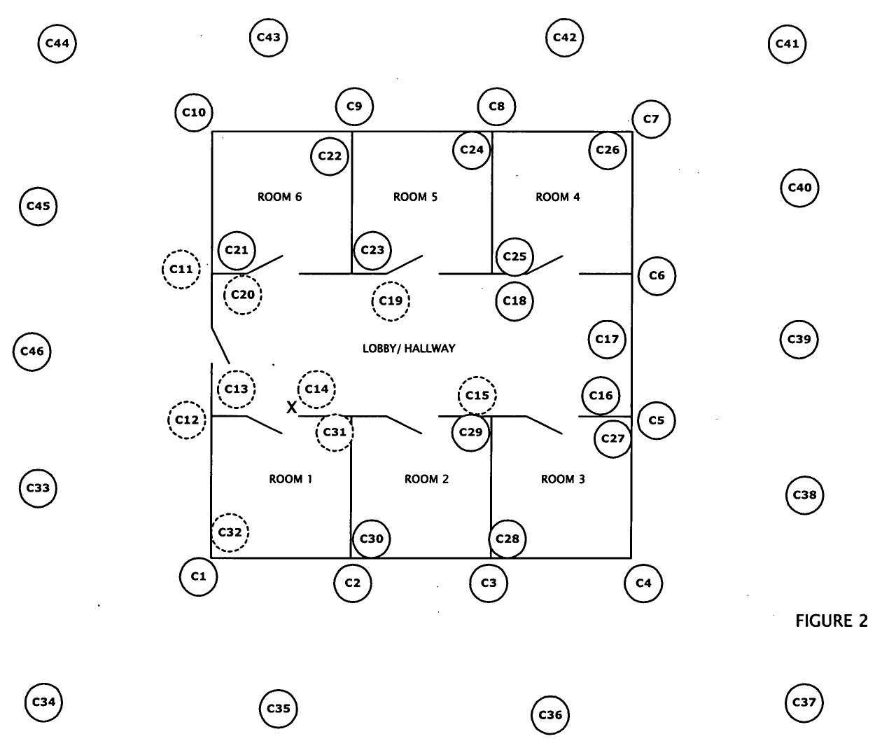

FIG. 2 is illustrative. FIG. 2 shows 46 video cameras C1-C46 mounted inside and outside of a building having six rooms and a hallway/lobby adjoining each room as shown. The video image feeds (and audio feeds if desired) from each camera C1-C46 are input into a computer system, which will digitize each signal to make the display easy to render and manipulate on a computer screen of FIG. 1 (of course, the signal may be digitized prior to feeding to the computer system as known in the art). As part of the system installation/configuration, each of the video cameras is associated with eight adjoining video cameras to form a nine-camera field of view. A partial table of such camera associations is shown in Table 1 below:

TABLE 1
Camera Zone Associations

| M | A1 | A2 | A3 | A4 | A5 | A6 | A7 | A8 |
|---|---|---|---|---|---|---|---|---|
| C10 | C8 | C9 | C43 | C44 | C45 | C46 | C11 | C12 |
| C11 | C1 | C10 | C12 | C13 | C44 | C45 | C46 | C33 |
| C12 | C1 | C11 | C13 | C20 | C45 | C46 | C33 | C34 |
| C13 | C14 | C19 | C20 | C11 | C12 | C45 | C46 | C33 |
| C14 | C15 | C19 | C20 | C13 | C31 | C32 | C11 | C12 |

In Table 1, only the associations of C10-C14 are shown, but an entry will be made for all video cameras in the system in the same manner. Thus, as shown in Table 1, when camera C10 is in the primary video camera such that its video image will be displayed as a primary video image in the main viewing area “M” as shown in FIG. 5, then cameras C8, C9, C43, C44, C45, C46, C11 and C12 will be considered the auxiliary video cameras to primary video camera C10 and the (auxiliary) video images from these auxiliary video cameras will be displayed in auxiliary viewing display areas A1-A8, respectively.

Thus, each video camera as a primary video camera can be logically associated with a number of (usually adjacent) auxiliary cameras during a configuration or commissioning stage. In addition to associating different physical cameras with a given camera, it may be desired to associate a different preset of the same camera as an associated auxiliary camera. Thus, a video camera could have a zoom setting as one associated auxiliary camera, and a wide-angle setting as another associated auxiliary camera, and a pan setting as another associated auxiliary camera, etc.

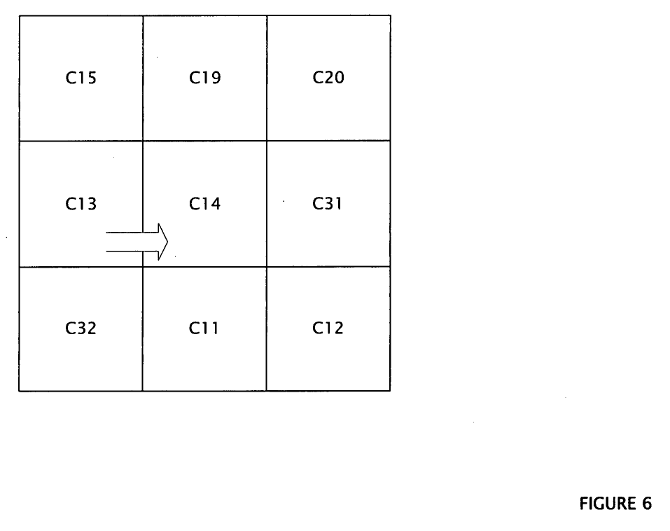

Referring again to FIG. 2, it is discovered by the operator that a potential intruder X is trying to enter Room 1. In this case X has attempted to use a fake swipe card, which has triggered an alert to the security operator. Since intruder X cannot gain entry, he will try to flee the building. Once the trigger is sent to the operator (visual and/or audible), the operator will look at the monitor and cause the image from video camera C14 to appear in the main viewing area as the initial primary video image, which is closest to the known location of X. As indicated by Table 1, this will cause the video images from cameras C15, C19, C20, C13, C31, C32, C11 and C12 to be shown as the auxiliary video images in auxiliary viewing areas A1-A8 respectively. These cameras are also shown in dashed circles in FIG. 2. This composite camera layout is shown graphically in FIG. 6. As a result, the operator may view a large area essentially centered around the primary area of interest of C14.

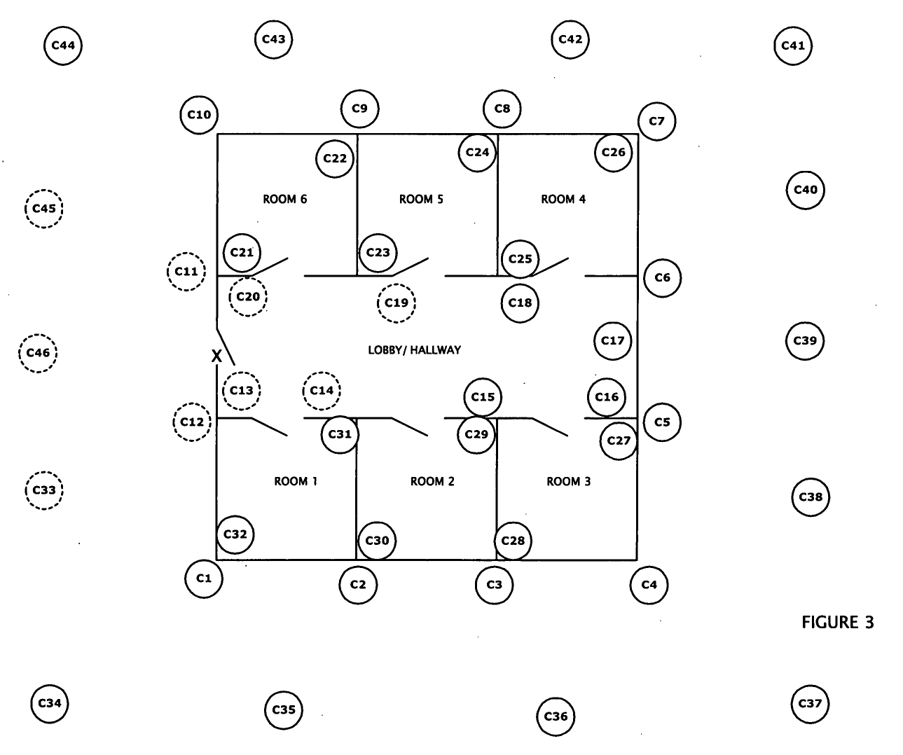

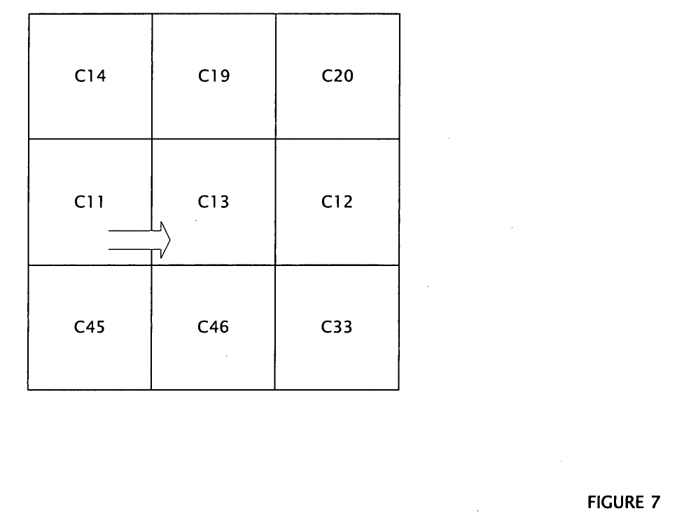

As the intruder X flees, he enters the field of view primarily covered by camera C13 (near the building exit door) as shown in FIG. 3. As the operator sees the intruder enter auxiliary region C13 of the screen of FIG. 6, he may then select the auxiliary video camera C13 with the computer mouse and drag it into the primary main area in the center of the screen. As a result, the video image feed from camera C13 is designated as a subsequent primary video image and placed in the main area M of the screen, and the eight auxiliary areas change view in accordance with Table 1. So, when the video image from camera C13 becomes the primary video image, then auxiliary areas A1-A8 are filled with the video image feeds from auxiliary cameras C14, C19, C20, C11, C12, C45, C46, and C33 respectively, as defined by Table 1 and shown in FIG. 7. These auxiliary video cameras are also shown in dashed circles in FIG. 3.

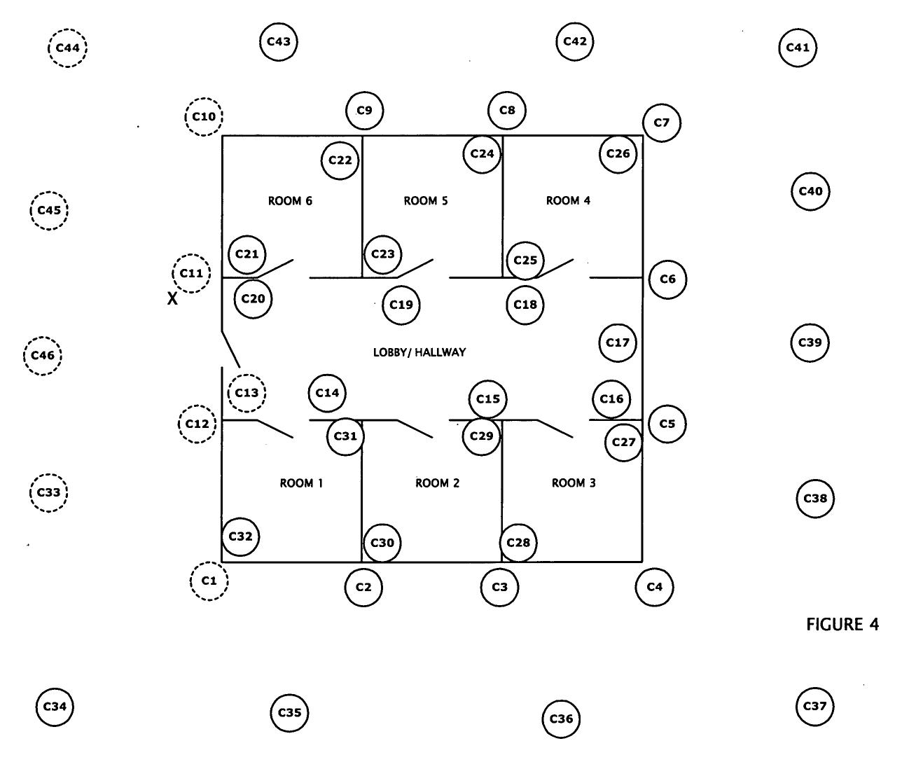

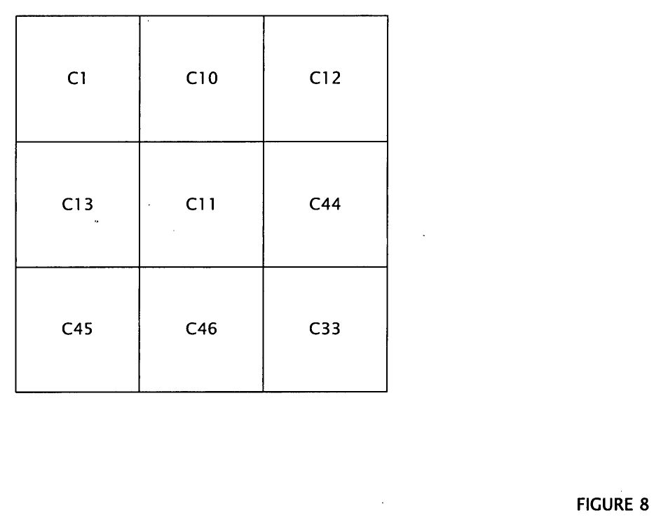

Next, as the intruder X continues to flee, he enters the field of view primarily covered by auxiliary video camera C11 as shown in FIG. 4. As the operator sees the intruder enter the auxiliary video image from camera C11 of the screen of FIG. 7, he may then select the C11 video camera and drag it into the primary main area in the center of the screen. As a result, the video image feed from camera C11 is designated as a subsequent primary video image and placed in the main area M of the screen, and the eight auxiliary areas change view in accordance with Table 1. So, when the video image from camera C11 becomes the primary video image, then auxiliary areas A1-A8 are filled with the video image feeds from auxiliary cameras C1, C10, C12, C13, C44, C45, C46, and C33 respectively, as defined by Table 1 and shown in FIG. 8. These auxiliary video cameras are also shown in dashed circles in FIG. 4.

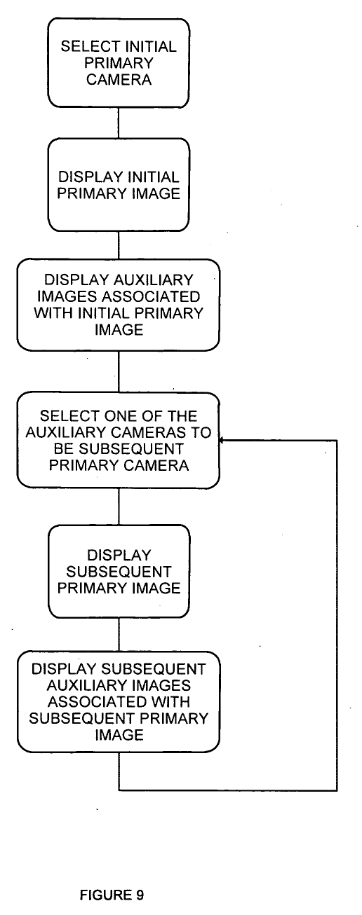

As shown by the flowchart of FIG. 9, this is a recursive process that enables the operator to select the auxiliary area that is entered by the intruder and have the system automatically regenerate the entire viewing screen to center the new zone of interest and populate the auxiliary zones with those cameras that are previously associated with that zone. This takes the guesswork out of the process while it is occurring and allows the operator to concentrate on helping the security team capture the intruder, etc.

Note that the operator may not have to drag the various screens but may simply select them in an alternative embodiment. In this case, selecting the desired screen such as by clicking or double-clicking it will cause the computer to automatically repopulate the auxiliary areas of the screen in accordance with the map as shown in Table 1.

In addition to displaying video image feeds from cameras, a viewing zone A1-A8 (or even M) may display secondary information such as the alleged intruder's card holder image, related POS/ATM/slots data, map information etc.

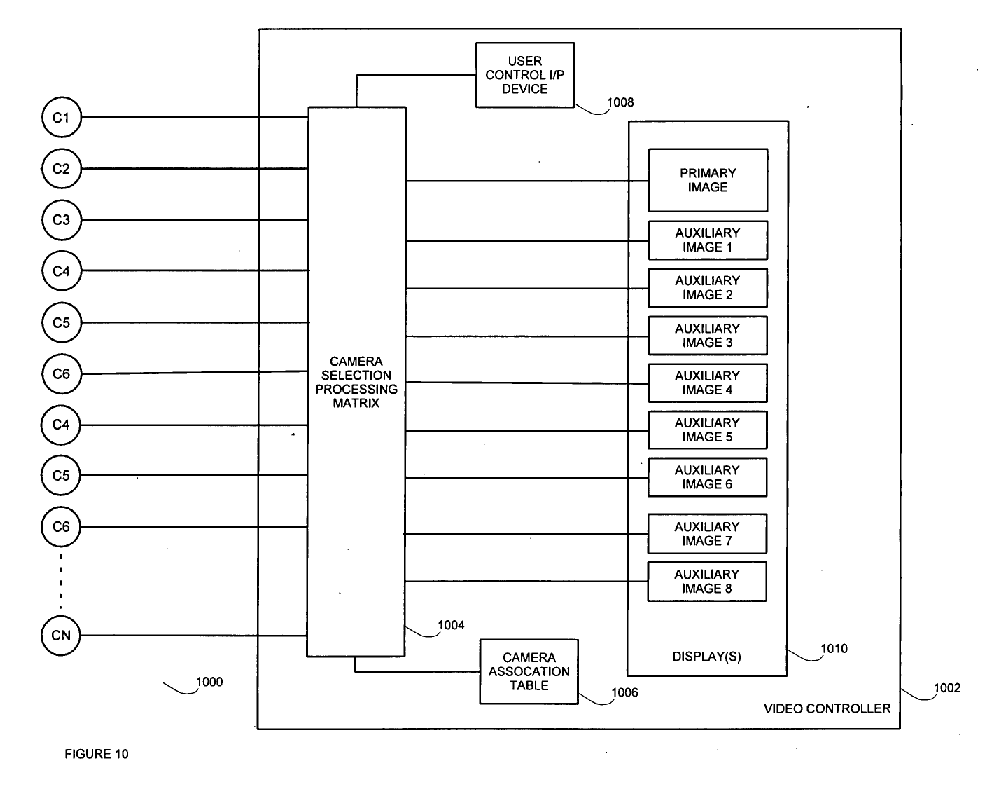

FIG. 10 illustrates a logical block diagram of the system 1000 of the present invention. Video cameras C1, C2, C3, . . . CN input their video image feeds to a video controller 1002 which includes a camera selection processing matrix 1004. The output of the camera selection processing matrix 1004 are then fed to one or more displays 1010 as a primary video image and auxiliary video image 1 through auxiliary video image 8. The selection of which cameras C1-CN will provide the primary video image is directly controlled by the user via a user control input device 1008 such as a computer mouse. After the user selects the camera to provide the desired primary video image, then the camera association table 1006 is accessed to determine the auxiliary cameras that have been previously associated with the selected primary video camera as previously described. The camera selection processing matrix 1004 will use the information from the camera association table 1006 to select the correct auxiliary cameras and feed the images from those auxiliary cameras to the display(s) 1010 accordingly. When the user selects the subsequent video image from the auxiliary images on the display 1010, then that newly selected image will be moved to the primary image viewing area and the camera association table 1006 is again accessed to determine the auxiliary cameras that have been previously associated with the subsequently selected primary video camera as previously described. The camera selection processing matrix 1004 will use the information from the camera association table 1006 to select the correct auxiliary cameras and feed the images from those auxiliary cameras to the display(s) 1010 accordingly. This process may be repeated as desired by the user.

Configurations may be adapted and reconfigured on the fly (during use), and then saved as profiles for later use. Also, an operator can choose any fields of view as desired and have the associated video feeds (or data screens) as described above.

What is claimed is:

1. A method of tracking an object of interest throughout an area under surveillance comprising a plurality of regions, said method comprising:
a. locating a plurality of video cameras so as to provide a video image associated with each of said regions;
b. for each of said video cameras as a primary video camera, associating a subset of said plurality of video cameras as auxiliary video cameras to said primary video camera;
c. selecting one of said video cameras as an initial primary video camera to display a video image therefrom as an initial primary video image;
d. displaying an auxiliary video image for each of the subset of auxiliary video cameras previously associated with said initial primary video camera;
e. selecting one of said auxiliary video cameras to become a subsequent primary video camera;
f. displaying the video image from the subsequent primary video camera as a subequent primary video image;
g. displaying a video image for each of the subset of auxiliary video cameras previously associated with said subsequent primary video camera.

2. The method of claim 2 further comprising repeating steps e, f, and g as desired.

3. The method of claim 1 wherein all of the video images are displayed on a single computer monitor.

4. The method of claim 3 wherein the video images are displayed in a matrix format with the primary video images being displayed in the center and the auxiliary video images displayed in a pattern surrounding the primary video image.

5. The method of claim 1 wherein the step of selecting one of said auxiliary video cameras to become a subsequent primary video camera comprises grabbing the auxiliary video image associated with the desired auxiliary video camera with a computer mouse and then draging the grabbed auxiliary video image to overlap the primary video image.

6. The method of claim 1 wherein the step of selecting one of said auxiliary video cameras to become a subsequent primary video camera comprises clicking on the auxiliary video image associated with the desired auxiliary video camera with a computer mouse.

7. The method of claim 1 wherein said auxiliary video images comprise a zoom image, a wide angle image, or a pan image.

8. A video surveillance system for tracking an object of interest throughout an area under surveillance comprising a plurality of regions, said system comprising:
a. a plurality of video cameras strategically located so as to provide a video image associated with each of said regions; and
b. a video controller interconnected with the plurality of video cameras, comprising:
i. memory adapted to store a table of associations of:
for each of said video cameras as a primary video camera, a subset of said plurality of video cameras as auxiliary video cameras associated with said primary video camera;
ii. an input device that enables the selection of one of said video cameras as an initial primary video camera to display a video image therefrom as an initial primary video image;
iii. a display device that provides for the displaying of the initial primary video image and an auxiliary video image for each of the subset of auxiliary video cameras previously associated with said initial primary video camera;
iv. wherein the input device further enables the selection of one of said auxiliary video cameras to become a subsequent primary video camera;
v. wherein the display further displays the video image from the subsequent primary video camera as a subequent primary video image;
vi. wherein the display further displays a video image for each of the subset of auxiliary video cameras previously associated with said subsequent primary video camera; and
vii. processing circuitry adapted to control the operation of the memory, the input device, and the display accordingly.

9. The system of claim 8 wherein all of the video images are displayed on a single computer monitor.

10. The system of claim 9 wherein the video images are displayed in a matrix format with the primary video images being displayed in the center and the auxiliary video images displayed in a pattern surrounding the primary video image.

11. The system of claim 8 wherein the input device is a computer mouse that enables the grabbing of the auxiliary video image associated with the desired auxiliary video camera and then draging the grabbed auxiliary video image to overlap the primary video image.

12. The system of claim 8 wherein the input device is a computer mouse that enables the clicking on the auxiliary video image associated with the desired auxiliary video camera.

13. The system of claim 8 wherein said auxiliary video images comprise a zoom image, a wide angle image, or a pan image.

14. A video controller for use in a video surveillance system for tracking an object of interest throughout an area under surveillance comprising a plurality of regions, the video controller being interoperable with a plurality of video cameras strategically located so as to provide a video image associated with each of said regions said system, the video controller comprising:
i. memory adapted to store a table of associations of:
for each of said video cameras as a primary video camera, a subset of said plurality of video cameras as auxiliary video cameras associated with said primary video camera;
ii. an input device that enables the selection of one of said video cameras as an initial primary video camera to display a video image therefrom as an initial primary video image;
iii. a display device that provides for the displaying of the initial primary video image and an auxiliary video image for each of the subset of auxiliary video cameras previously associated with said initial primary video camera;
iv. wherein the input device further enables the selection of one of said auxiliary video cameras to become a subsequent primary video camera;
v. wherein the display further displays the video image from the subsequent primary video camera as a subequent primary video image;
vi. wherein the display further displays a video image for each of the subset of auxiliary video cameras previously associated with said subsequent primary video camera; and
vii. processing circuitry adapted to control the operation of the memory, the input device, and the display accordingly.

15. The video controller of claim 14 wherein all of the video images are displayed on a single computer monitor.

16. The video controller of claim 15 wherein the video images are displayed in a matrix format with the primary video images being displayed in the center and the auxiliary video images displayed in a pattern surrounding the primary video image.

17. The video controller of claim 14 wherein the input device is a computer mouse that enables the grabbing of the auxiliary video image associated with the desired auxiliary video camera and then draging the grabbed auxiliary video image to overlap the primary video image.

18. The video controller of claim 14 wherein the input device is a computer mouse that enables the clicking on the auxiliary video image associated with the desired auxiliary video camera.

19. The video controller of claim 14 wherein said auxiliary video images comprise a zoom image, a wide angle image, or a pan image.
